(19) United States
(12) Patent Application Publication
(10) Pub. No.: US 2009/0211924 A1
(43) Pub. Date: Aug. 27, 2009

(54) pH Electrode and Electrolyte

(76) Inventors: Steven J. West, Hull, MA (US); Zhisheng Sun, Hopkinton, MA (US)

Correspondence Address: Richard L. Sampson;SAMPSON & ASSOCIATES, P.C., 50 Congress Street, Boston, MA, 02109, US

(21) Appl. No.: 12/361,385

(22) Filed: Jan. 28, 2009

Related U.S. Application Data
(60) Provisional application No. 61/031,114, filed on Feb. 25, 2008.

(51) Int. Cl. G01F 1/64

(52) U.S. Cl. 205/787.5; 204/433

(57) ABSTRACT

A pH half-cell method and apparatus includes an electrode, a pH sensitive glass membrane and an electrolyte in electrolytic contact with the electrode and membrane. The membrane includes at least about 15 mole percent lithium, and the electrolyte includes a lithium salt as the predominant monovalent cation. The pH half-cell is used with a reference half-cell and meter to provide an electrochemical potential measurement sensor, optionally with both half-cells disposed within a single housing. The lithium salt electrolyte is also used in a method for storing, conditioning, preserving and/or rehabilitating a pH half-cell.

### RELATED APPLICATION

This application claims the benefit of U.S. Provisional Application Ser. No. 61/031,114, entitled Electrolyte for pH Electrodes, filed on Feb. 25, 2008, the contents of which are incorporated herein by reference in their entirety for all purposes.

### BACKGROUND

1. Technical Field

The present invention generally relates to electrochemical sensors and more particularly to measuring half-cells for use in pH measurement.

2. Background Information

Throughout this application, various publications, patents and published patent applications are referred to by an identifying citation. The disclosures of the publications, patents and published patent applications referenced in this application are hereby fully incorporated by reference into the present disclosure.

Electrochemical potential measurements are commonly used to determine solution pH, other selective ion activities, ratios of oxidation and reduction activities, as well as other solution characteristics. A conventional pH/ion selective electrode/oxidation reduction potential meter (hereafter referred to as a pH/ISE/ORP meter) is typically a modified voltmeter that measures the electrochemical potential between a reference half-cell (of known potential) and a measuring half-cell. These half-cells, in combination, form a cell, the electromotive force (emf) of which is equal to the algebraic sum of the potentials of the two half-cells. The meter is used to measure the total voltage across the two half-cells. The potential of the measuring half-cell is then determined by subtracting the known potential of the reference half-cell from the total voltage value.

The measuring half-cell typically includes an ion selective material such as glass. The potential across the ion selective material is well known by those of ordinary skill in the art to vary in a manner that may generally be described by the Nernst Equation, which expresses the electrochemical potential as a logarithmic function of ion activity (thermodynamically corrected concentration). A pH meter is one example of a pH/ISE/ORP meter in which the activity of hydrogen ions is measured. pH is defined as the negative logarithm of the hydrogen ion activity and is typically proportional to the measured electrochemical potential.

Referring to FIG. 1, a typical, prior art arrangement 20 for measuring electrochemical potential, such as pH, is shown. Arrangement 20 typically includes a measuring half-cell 30 and a reference half-cell 40 immersed in a process solution 24 and connected to an electrometer 50 by connectors 38 and 48, respectively. Measuring half-cell 30 and reference half-cell 40 are often referred to commercially (as well as in the vernacular) as measuring (e.g., pH) electrodes and reference electrodes, respectively. Electrometer 50 functions similarly to a standard voltage meter in that it measures a D.C. voltage (electrochemical potential) between measuring half-cell 30 and reference half-cell 40. Measuring half-cell 30 typically includes a half-cell electrode 36 immersed in a half-cell electrolyte 32, which in pH measurements is typically a standard solution including a pH buffering agent and potassium chloride. For pH measurement, measuring half-cell 30 also includes an ion selective material 34 which permits electrochemical contact between the electrolyte 32 and the process solution.

The purpose of the reference half-cell 40 is generally to provide a stable, constant (known) potential against which the measuring half-cell may be compared. Reference half-cell 40 typically includes a half-cell electrode 46 immersed in a half-cell electrolyte 42. Electrochemical contact between the reference electrolyte 42 and the process solution is typically established through a reference junction 44, which is typically sufficiently porous to allow a low resistance contact with the process solution 24.

As used herein, the term “half-cell electrode” refers to the solid-phase, electron-conducting material in combination with the half-cell electrolyte, at which contact the oxidation-reduction reaction occurs that establishes an electrochemical potential. Half-cell electrolyte 32 is hereafter referred to as pH electrolyte.

In the field of pH measurement with glass electrodes, it is well known that prolonged exposure of the pH-sensitive glass membrane 34 to test solutions 24 degrades performance, especially at elevated temperatures. One aspect of the performance degradation is an increase in the electrical resistance of the glass membrane. Increase in membrane resistance beyond a certain point generally renders the electrode 30 nonfunctional.

Most modern pH glasses 34 are of the lithia family, the principal components of which are the oxides of silicon and lithium—silica and lithia. Glass compositions are generally described by the mole percentage of the cationic constituents with the understanding that the rest of the mass will be accounted for by oxygen. Typically, the mole percentage of lithium is within 25% to 35%. There are typically smaller percentages of components such as lanthanum, cesium, barium, calcium, tantalum and or many other possible constituents that contribute to specific performance characteristics of the glass. These lesser components are generally present at less than 10 mole percent each and in totality less than 20 mole percent. The balance is silicon, amounting to between about 45 and 70 mole percent.

pH glasses 34 have a slight electrical conductivity and in lithia glasses the charge is carried by lithium cations which under thermal excitation are capable of hopping between fixed negatively charged sites in the oxide network. Other alkali ions such as sodium or potassium also have mobility in these glasses but are generally not included in formulations optimized for the measurement of pH.

Many applications of glass pH electrodes involve exposure to solutions at elevated temperature, either during the actual pH measurement or in order to sterilize the electrode between measurements. For decades, investigators have experimented with glass formulations in order to optimize performance and lifetime when exposed to elevated temperatures. For example, comprehensive studies were carried out by Perley and reported in his 1949 article in Analytical Chemistry (Vol. 21, No. 3, March 1949, pp. 394-401). Perley offers the following comment on an interesting dilemma faced by investigators:
“High lithium oxide content of pH glasses, which favor initially low electrical resistance, is always associated with relatively large increases in resistance with time of use. Thus, it is not easy to produce robust types of glass electrodes which have relatively low and stable electrical resistances.”

In other words, achievement of the two goals—low resistivity and robustness at elevated temperature—has long been recognized as very challenging.

In addition, many investigators have ascribed the increase in resistivity of glass electrodes to changes near the surfaces of the glass in what is typically called the “gel layer” or “leached layer”. The leached layer is known to exchange ions with the solution in contact with it, a process often referred to as corrosion of the glass. Alkali ions, such as lithium or sodium, diffuse from the surface layer of the glass to the solution and are typically replaced with hydrogen ions which have a lower mobility in the glass and therefore have less capacity for carrying current. This results in higher resistivity as reported, for example, by Morf (Electroanalysis 1995, No. 9, pp. 852-858):
“From the corrosion rate found at 25° C. . . . a surface resistance Rₛ˜100 MΩ is obtained, which turns out to be a large contribution to the total resistance Rₘ of usually around 200-400 MΩ.”

A need therefore exists for improvements which address the aforementioned drawbacks, to provide pH electrodes with low resistivity and robustness at elevated temperatures for enhanced useful life.

### SUMMARY

In one aspect of the instant invention, a pH half-cell includes an electrode, an electrolyte in electrolytic contact with the electrode, and a pH sensitive glass membrane in electrolytic contact with the electrolyte, so that an electrical pathway is provided from the electrolyte through the glass membrane. The membrane includes at least about 15 mole percent lithium, and the electrolyte includes a lithium salt. In a variation of this aspect, an electrochemical potential measurement sensor includes the foregoing pH half-cell and a reference half-cell.

In another aspect of the invention, a method for measuring electrochemical potential includes inserting the foregoing pH half-cell and reference half-cell into a liquid, and electrically connecting the half-cells to a voltage meter to generate a total voltage value. The potential of the reference half-cell is subtracted from the total voltage value.

In still another aspect, a method of fabricating a pH half-cell includes providing an electrode, placing the electrode in electrolytic contact with an electrolyte, and placing a pH sensitive glass membrane in electrolytic contact with the electrolyte, so that an electrical pathway is provided from the electrolyte through the glass membrane. The glass membrane is configured to include at least 15 mole percent lithium, and the electrolyte is configured to include a lithium salt.

Yet another aspect of the invention includes an electrolyte for use with a pH half-cell, which includes a lithium salt as the predominant monovalent cation. In a variation of this aspect, a method for storing, conditioning, preserving and/or rehabilitating a pH half-cell, includes placing the pH half-cell in a bath of this electrolyte.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a schematic view of a prior art arrangement for measuring pH;

FIG. 2 is a schematic view of an embodiment of a pH electrode of the present invention; and

FIGS. 3-6 are graphical representations of test results of exemplary embodiments of the present invention.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. In addition, well-known structures, circuits and techniques have not been shown in detail in order not to obscure the understanding of this description. The following detailed description is, therefore, not to be taken in a limiting sense, and the scope of the present invention is defined by the appended claims and their equivalents. For clarity of exposition, like features shown in the accompanying drawings are indicated with like reference numerals and similar features as shown in alternate embodiments in the drawings are indicated with similar reference numerals.

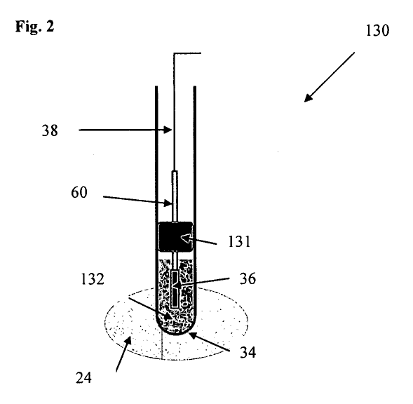

Referring now to FIG. 2, exemplary embodiments of the present invention are incorporated into a pH electrode (half-cell) 130 having an ion-selective membrane in the form of dome-shaped glass bulb 34. Electrode 130 includes an internal electrolyte 132 which includes a pH buffering agent and chloride. The chloride serves to establish a stable inner potential with respect to a half-cell electrode 36 which, for example, includes a silver-chloride coating over a silver wire 60 connected to measurement lead 38. As also shown, a seal 131 may be provided to contain electrolyte 132 in contact with the electrode 36 as shown. As will be discussed in greater detail hereinbelow, a novel formulation is used for electrolyte 132, which, in exemplary embodiments, includes lithium chloride (LiCl) rather than (or in addition to) the conventional potassium chloride (KCl).

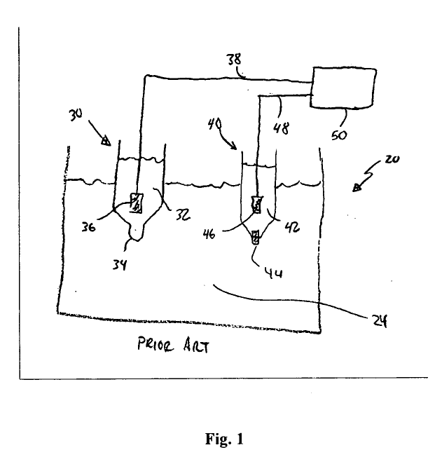

An aspect of the present invention was the recognition by the instant inventor of the mechanism underlying the aforementioned problem of increased resistance of pH electrodes, particularly upon exposure to relatively high temperatures. This inventor conceived of the instant solution while characterizing the resistivity increase in pH glass when exposed to elevated temperatures. Conventional pH half-cells 30 (FIG. 1) with membranes in the form of dome-shaped bulbs 34 (containing a conventional KCl and pH buffering agent electrolyte 32) were investigated and found to have initial resistances of less than 20 MΩ. Exposure for a period of 17 hours in water at 135° C. (pressurized to prevent boiling) were found to increase resistances to greater than 1000 MΩ. Additional exposures were found to continue the resistance increases to greater than 2000 MΩ. It was reasoned based on the scientific literature (e.g., as discussed hereinabove) that the resistance increase was largely confined to surface layers, so these layers were etched away with hydrofluoric acid in an attempt to restore the low resistance. However, only a negligible decrease in resistance was achieved, leading to the suspicion that in contrast to conventional wisdom in the art, the resistivity increase occurred throughout the bulk of the glass membrane, rather than on only the surface layers.

The instant inventor then investigated a novel proposal, i.e., that perhaps the increase in membrane resistance was not necessarily generated, as commonly thought, by the aforementioned exchange of alkali ions from the glass 34 and with hydrogen ions from the process solution 24. Rather, the inventor realized that the increase in membrane resistance was due to leaching of lithium ions from the glass into the electrolyte 32, which were then exchanged in the bulk glass matrix with less mobile potassium ions from the electrolyte. As discussed hereinbelow, this proposal was investigated using a low resistivity glass composition, e.g., in which the charge carriers—lithium ions—are relatively mobile in the silicate network.

Thus, an aspect of the present invention is the provision of an internal electrolyte 132 for pH electrodes, which contains a lithium salt in place of the commonly used potassium salt. Use of such an electrolyte 132 has been found to prolong the useful life of a pH electrode, particularly when exposed to elevated temperatures. Another aspect of the invention includes the use of this lithium-based electrolyte for storing and/or re-conditioning pH electrodes for improved performance.

The results achieved in the test examples discussed hereinbelow were surprising in view of the decades of careful studies by many investigators which failed to suggest the use of lithium ion in electrolytes contacting the glasses 34. The instant discovery also offers an explanation of why low-resistivity glasses tend to show a more rapid increase in resistivity with aging than high-resistivity glasses. Both types of glass typically have about the same initial concentration of lithium ions-about 25-35 mole % with respect to other cationic species-but in low-resistivity compositions the lithium ions have been found to be far more mobile and thus leach out faster.

Turning back to FIG. 2, in particular embodiments, a pH half-cell 130 in accordance with the present invention includes an electrode 36, such as one containing silver-silver chloride (e.g., as a coating 36 on a silver wire 60). Electrode 36 is disposed within a pH sensitive glass membrane 34, with an electrolyte 132 disposed in electrolytic contact with both the electrode 36 and the membrane 34, so that an electrical pathway is provided from electrode 36, through electrolyte 132, through the glass membrane 34. Membrane 34 includes at least 15 mole percent lithium.

In particular embodiments, glass membrane 34 includes at least about 25 mole percent lithium. Optional embodiments may include lithium within a range of about 25 to 35 mole percent, along with, as a further option, about 45 to 70 mole percent silicon. As still further options, the glass membrane 34 may include up to about 20 mole percent of materials such as lanthanum, cesium, barium, calcium, tantalum, and combinations thereof.

Electrolyte 132 includes a lithium salt as the predominant monovalent cation. In particular embodiments, electrolyte 132 may include a lithium chloride solution at a concentration within a range of, for example, about 0.01M to 10M. Optionally, electrolyte 132 may also include a pH buffer. Suitable pH buffers include those which are compatible with lithium, e.g., those which do not tend to precipitate out lithium or lithium products. One example of such a lithium compatible pH buffer includes MOPS (3-(N-morpholino)propanesulfonic acid). Other materials that may be used as pH buffers include various organic acids such as 3-(N-morpholino)-2-hydroxypropanesulfonic acid (MOPSO), N-(2-hydroxyethyl)piperazine-N′-(2-ethanesulfonic acid) (HEPES), 2-(N-morpholino)ethanesulfonic acid(MES), piperazine-N,N′-bis(2-ethanesulfonic acid) (PIPES), 3-[N,N-bis(2-hydroxyethyl)amino]-2-hydroxypropanesulfonic acid (DIPSO), 2-bis(2-hydroxyethyl)amino-2-(hydroxymethyl)-1,3-propanediol(BIS-TRIS) and other biological buffers, such as those commonly known as Good's buffers (Good et al: Biochemistry, 5,467-77(1966), Ferguson et al., Analytical Biochemistry, 104, 300-310 (1980)). Suitable pH buffers may be provided in various concentrations, along with various concentrations of LiCl, depending on the particular application. In various embodiments, the pH buffer concentration may be within a range of about 0.01 to about 2 M. In one particular example, MOPS at a concentration of 0.15 M combined with 1M LiCl, has been shown to operate successfully in a broad range of conditions. In still further embodiments, the electrolyte may include additional materials, such as silver, silver-silver chloride, mercury-mercurous sulfate, mercury-mercurous chloride, platinum-triiodide/iodide and other redox couples and/or combinations thereof.

In other embodiments, an electrochemical potential measurement sensor includes a conventional reference half-cell 40 (FIG. 1) in combination with any of the aforementioned embodiments of pH half-cell 130. The pH half-cell 130 and reference half-cell 40 (or various components thereof) may be disposed in a common housing 134 (FIG. 7) and coupled to a meter 50. In particular embodiments, meter 50 may include a process variable transmitter, such as the Model 870ITPH transmitter commercially available from Invensys Systems, Inc. In addition, pH half-cell 130 may be sized and shaped for removable insertion into the sensor housing 134.

For example, referring now to FIG. 7, a sensor housing 134 may be configured to removably receive pH half-cell 130 therein, along with operative components of reference half-cell 40, to form a unitary combination sensor 130′. Housing 134 thus includes reference half-cell electrode 46 immersed in a half-cell electrolyte 42, and a seal 131′ to contain electrolyte 42 as shown. Housing 134 also includes a conventional reference junction 44 to establish electrochemical contact between the reference electrolyte 42 and the process solution 24. Sensor 130′ thus provides a unitary device (that thus requires only a single process penetration) capable of enabling both reference measuring electrodes to contact the process solution. Those skilled in the art will recognize that reducing the number of process penetrations tends to reduce the potential for leakage of the process fluid. This may be particularly advantageous in applications such as those involving caustic or otherwise hazardous process fluids flowing through complex pipeline systems.

It should be noted that in the embodiment shown, sensor 130′ may include a sleeve or other barrier disposed about pH electrode 130 to substantially prevent contact between pH electrode 130 and reference electrolyte 42.

Other aspects of the invention include an electrolyte as described hereinabove as electrolyte 132, for use with a pH half-cell, which includes a lithium salt, optionally with a pH buffer such as also described hereinabove. In particular embodiments, the electrolyte includes MOPS at a concentration of 0.15 M, and 1M LiCl.

Turning now to Tables I-III, methods associated with the present invention will now be described.

TABLE I

| | |
|---|---|
| 200 | providing a pH half-cell |
| 202 | providing a reference half-cell |
| 204 | inserting the reference half-cell and pH half-cell into a process |
| | solution |
| 206 | electrically connecting said reference half-cell and said pH |
| | half-cell to a meter |
| 208 | using the meter to generate a total voltage value, and |
| 210 | subtracting the potential of the reference half-cell from the total |
| | voltage value |

TABLE II

| | |
|---|---|
| 220 | providing an electrode |
| 222 | disposing an electrolyte in electrolytic contact with the electrode |
| 224 | disposing a pH sensitive glass membrane in electrolytic contact |
| | with the electrolyte |
| 226 | configuring the membrane to include at least 15 mole percent |
| | lithium, and |
| 228 | configuring the electrolyte to include a lithium salt |

TABLE III

| | |
|---|---|
| 230 | disposing the pH half-cell 130 in a lithium salt solution. |
| 232 | Optionally, disposing the pH half-cell 130 in a lithium salt |
| | electrolyte |

Referring to Table I, a method for measuring electrochemical potential includes providing 200 a pH half-cell 130 such as shown and described with reference to FIG. 2, and providing 202 a reference half-cell 40. Both half-cells 130 and 40 are inserted 204 a process solution 24. Half-cells 130 and 40 are electrically connected 206 to a meter 50, which is used to generate 208 a total voltage value. The potential of the reference half-cell 40 is subtracted 210 from the total voltage value to yield the potential associated with the pH half-cell 130.

Turning now to Table II, a method of fabricating a pH half-cell includes providing 220 an electrode 36, disposing 222 an electrolyte 132 in electrolytic contact with the electrode 36, and disposing 224 a pH sensitive glass membrane 34 in electrolytic contact with the electrolyte, to provide an electrical pathway from the electrode, through the electrolyte and through the glass membrane. The membrane 34 is configured 226 to include at least 15 mole percent lithium, and the electrolyte 132 is configured to include a lithium salt.

As shown in Table III, a method for storing, conditioning, preserving and/or rehabilitating a pH half-cell 130, includes disposing 230 the pH half-cell in a lithium salt solution. Optionally, the method includes disposing 232 the pH half-cell in electrolyte 132.

The following illustrative examples demonstrate certain aspects and embodiments of the present invention, and are not intended to limit the present invention to any one particular embodiment or set of features.

### EXAMPLES

The following Examples used a glass membrane 34 having the following glass composition as described by C.C. Young in U.S. Pat. No. 4,028,196:

| Component | Mole % |
|---|---|
| SiO₂ | 55 |
| Li₂O | 34 |
| Cs₂O | 1 |
| La₂O₃ | 5 |
| Ta₂O₅ | 5 |

Young found that the inclusion of Ta₂O₅ was a significant factor in providing low resistivity. This is presumed to be because pentavalent tantalum replaces tetravalent silicon at points in the network, necessitating the existence of vacant negative sites in order to maintain bulk electroneutrality. These vacant sites are available for the hopping cations, to provide relatively low initial resistivity, albeit at a cost of relatively rapid aging as discussed above. The following Examples show, however, that such rapid aging is mitigated by use of a lithium-based electrolyte in accordance with the present invention, to provide both low resistivity and relatively long life/robustness.

### Example 1

Two pH half-cells were constructed substantially as shown and described with respect to FIG. 2, with a membrane 34 formulated in accordance with U.S. Pat. No. 4,028,196. One of the pH half-cells was filled with conventional electrolyte (0.3M KCl, 0.06M Na2HPO4, 0.09M KH2PO4) and the other with 1M LiCl in accordance with the present invention. The two half-cells were exposed to water at 135° C. (at 40 psig to prevent boiling off). They were periodically removed and their membrane resistances measured at about 20 to 25° C. The results are shown in FIG. 3, which show that the resistance increase of the half-cell having LiCl (Curve B) is significantly less than that of the half-cell having the conventional electrolyte (Curve A).

### Example 2

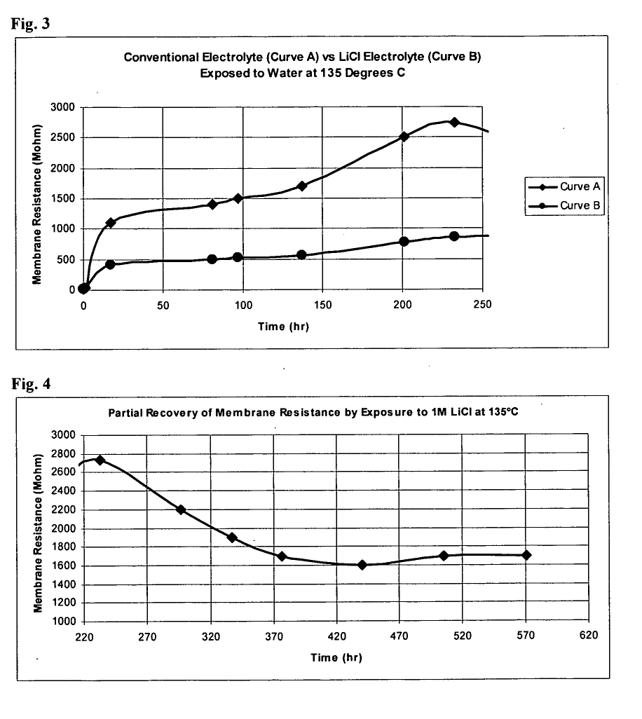

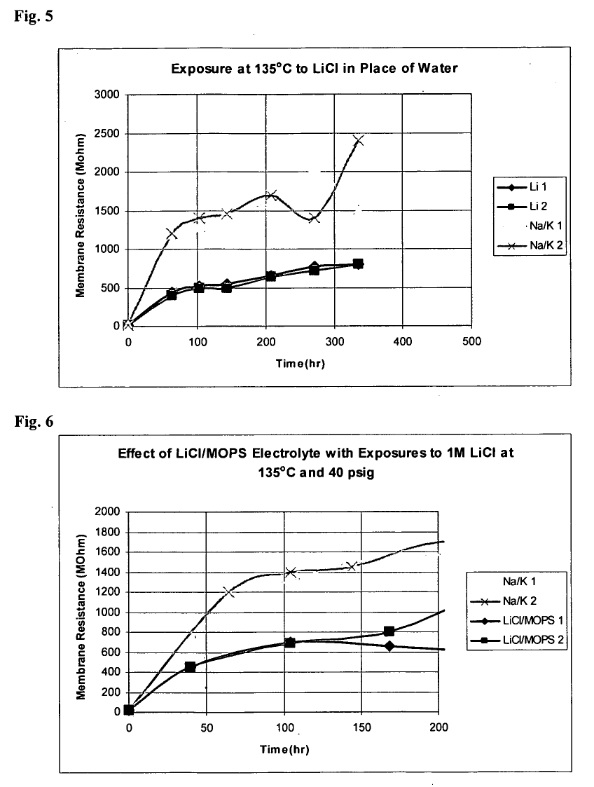

The conventional half-cell of Example 1 (Curve A) was then exposed to a bath of the 1M LiCl electrolyte of the present invention, at 135° C. and 40 psig. When this cell was periodically removed from the bath and its membrane resistance measured, the resistance was found to decrease over time, suggesting that lithium ions may be restored to the glass matrix. These results are plotted in FIG. 4, and suggest that the use of lithium ion-containing solutions may be beneficially used for the storage, conditioning, preservation, and/or recovery of compromised electrodes.

### Example 3

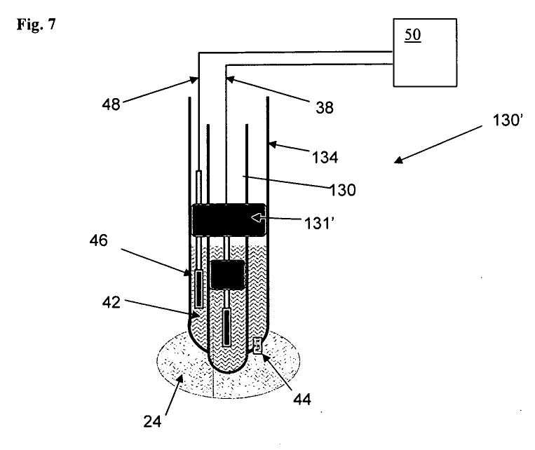

Two pH half-cells of each of the types used in Example 1, i.e., conventional electrolyte (Na/K), and the inventive electrolyte (LiCl), were exposed at 135° C. and 40 psig to a bath of 1M LiCl as external bathing electrolyte. When these cells were periodically removed from the bath and their membrane resistances measured, it was found that the amount of resistance increase was less for both types of half-cells than found in Example 1, indicating that use of LiCl on the external surface of the membrane 34 is beneficial, as illustrated in FIG. 5.

### Example 4

pH half-cells were provided substantially as described in Example 3, but for the addition of an inventive pH buffer (MOPS) to the internal electrolyte of the two half-cells having the LiCl internal electrolyte. Conventional phosphate buffers are often used to maintain the pH of conventional electrolytes at 7.00, but tend to generate lithium phosphate precipitates when used with LiCl electrolytes of the present invention. In this example, the 1M LiCl internal electrolyte was combined with the MOPS buffer, (3-(N-morpholino)propanesulfonic acid) at a concentration of 0.15 M, to help maintain the pH of this electrolyte at 7.00. All four of the half-cells were exposed to a 1M LiCl bath substantially as in Example 3. As shown in FIG. 6, the buffered LiCl internal electrolyte was shown to provide substantially the same beneficial effect on membrane resistance as non-buffered LiCl of Example 3.

It should be understood that any of the features described with respect to one of the embodiments described herein may be similarly applied to any of the other embodiments described herein without departing from the scope of the present invention.

In the preceding specification, the invention has been described with reference to specific exemplary embodiments for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

Having thus described the invention, what is claimed is:

1. A pH half-cell comprising:
an electrode;
an electrolyte disposed in electrolytic contact with the electrode;
a pH sensitive glass membrane disposed in electrolytic contact with the electrolyte, wherein an electrical pathway is provided from the electrolyte through the glass membrane;
the membrane including at least about 15 mole percent lithium; and
the electrolyte including a lithium salt.

2. The pH half-cell of claim 1, wherein the membrane includes at least about 25 mole percent lithium.

3. The pH half-cell of claim 1, wherein said electrolyte comprises a lithium salt as the predominant monovalent cation.

4. The pH half-cell of claim 3, wherein said electrolyte comprises LiCl.

5. The pH half-cell of claim 3, wherein said electrolyte comprises lithium at a concentration within a range of:
at least about 0.01M;
to about 10 M.

6. The pH half-cell of claim 3, wherein said electrolyte further comprises a pH buffer.

7. The pH half-cell of claim 6, wherein said electrolyte comprises a pH buffer selected from the group consisting of MOPS, MOPSO, HEPES, MES, PIPES, BIS-TRIS, DIPSO, Good's buffers, and mixtures and combinations thereof.

8. The pH half-cell of claim 7, comprising said pH buffer at a concentration within a range of:
at least about 0.01M,
to about 2 M.

9. The pH half-cell of claim 7, wherein said electrolyte comprises MOPS at a concentration of at least about 0.15 M, and at least about 1M LiCl.

10. The pH half-cell of claim 1 wherein said electrolyte comprises a member of the group consisting of silver, silver-silver chloride, mercury-mercurous sulfate, mercury-mercurous chloride, platinum-triiodide/iodide and other redox couples.

11. The pH half-cell of claim 1 wherein said electrode comprises silver-silver chloride.

12. The pH half-cell of claim 1, wherein said glass membrane comprises lithium within a range of:
at least about 25 mole percent;
to about 35 mole percent.

13. The pH half-cell of claim 12, wherein said glass membrane comprises silicon within a range of:
at least about 45 mole percent;
to about 70 mole percent.

14. The pH half-cell of claim 13, wherein said glass membrane further comprises up to about 20 mole percent of a material selected from the group consisting of lanthanum, cesium, barium, calcium, tantalum, and combinations thereof.

15. An electrochemical potential measurement sensor comprising:
a reference half-cell; and
the pH half-cell of claim 1.

16. The sensor of claim 15 wherein said pH half-cell and said reference half-cell are disposed in a common housing and coupled to an electrometer.

17. The sensor of claim 16, wherein said electrometer comprises a process variable transmitter.

18. The sensor of claim 16 wherein said pH half-cell is sized and shaped for removable insertion into said housing.

19. A method for measuring electrochemical potential comprising:
(a) providing the pH half-cell of claim 1;
(b) providing a reference half-cell;
(c) inserting said reference half-cell and said pH half-cell into a liquid;
(d) electrically connecting said reference half-cell and said pH half-cell to a meter;
(e) using the meter to generate a total voltage value; and
(f) subtracting the potential of the reference half-cell from the total voltage value.

20. A method of fabricating a pH half-cell comprising:
(a) providing an electrode;
(b) disposing an electrolyte in electrolytic contact with the electrode;
(c) disposing a pH sensitive glass membrane in electrolytic contact with the electrolyte, wherein an electrical pathway is provided from the electrolyte through the glass membrane;
(d) configuring the membrane to include at least 15 mole percent lithium; and
(e) configuring the electrolyte to include a lithium salt.

21. An electrolyte for use with a pH half-cell, comprising a lithium salt as the predominant monovalent cation.

22. The electrolyte of claim 21, wherein said lithium is present at a concentration within a range of:
at least about 0.01M;
to about 10 M.

23. The electrolyte of claim 21, further comprising a pH buffer.

24. The electrolyte of claim 23, further comprising a pH buffer selected from the group consisting of MOPS, MOPSO, HEPES, MES, PIPES, BIS-TRIS, DIPSO, Good's buffers, and mixtures and combinations thereof.

25. The electrolyte of claim 24, wherein said pH buffer is disposed at a concentration within a range of:
at least about 0.01M;
to about 2 M.

26. The electrolyte of claim 24, comprising MOPS at a concentration of at least about 0.15 M, and at least about 1M LiCl.

27. A method for storing, conditioning, preserving and rehabilitating a pH half-cell, comprises disposing the pH half-cell in a bath of the electrolyte of claim 21.
